(19) United States
(12) Patent Application Publication
(10) Pub. No.: US 2025/0389649 A1
(43) Pub. Date: Dec. 25, 2025

(54) Hydrocarbon Gas Detection System and Camera Arrangement Thereof

(71) Applicant: Ningbo Oiler Technology Company Limited, Ningbo City (CN)

(72) Inventors: Bo Fu, Ningbo City (CN); Ziliang Mao, Ningbo City (CN)

(21) Appl. No.: 19/221,446

(22) Filed: May 28, 2025

Related U.S. Application Data
(60) Provisional application No. 63/662,216, filed on Jun. 20, 2024.

(30) Foreign Application Priority Data
Sep. 2, 2024 (CN) 202411219745.7

(51) Int. Cl. G01N 21/3504; G01M 3/04; G06T 7/13; G06T 7/269; G06T 7/73; H04N 7/18; H04N 23/20

(52) U.S. Cl. CPC G01N 21/3504; G01M 3/04; G06T 7/13; G06T 7/269; G06T 7/73; H04N 7/18; H04N 23/20; G06T 2207/10016; G06T 2207/10048; G06T 2207/20036; G06T 2207/30232

(57) ABSTRACT

A hydrocarbon gas detection system including a longwave infrared camera, a spectral filter, and a computation unit. The spectral filter is disposed in the light path of the camera sensor. The spectral filter is made of a material selected from the group consisting of calcium fluoride, zinc sulfide, magnesium fluoride, and silicon. The computation unit is arranged to process image data of the longwave infrared camera for the hydrocarbon gas detection.

### CROSS REFERENCE OF RELATED APPLICATION

This application is a non-provisional application that claims the benefit of priority under 35U.S.C. § 120 to a provisional application, application No. 63/662,216, filing date Jun. 27, 2024, this application also is a non-provisional application that claims priority under 35U.S.C. § 119 to China application number CN202411219745.7, filing date Sep. 2, 2024, wherein the entire content of which is expressly incorporated herein by reference.

### BACKGROUND OF THE PRESENT INVENTION

### Field of Invention

The present invention relates generally to hydrocarbon gas detection, and more particularly to a longwave infrared system for hydrocarbon gas detection and quantification.

### Description of Related Arts

Industrial hydrocarbon gas detection is important in many industrial settings. Hydrocarbon gases are among the major pollutants emitted in the petrochemical industry. They are usually flammable and harmful to the environment. Among the many hydrocarbon gases, methane has attracted enormous attention in recent years. Methane is the main component of natural gas. It is odorless, colorless, highly flammable, and can trap heat in the atmosphere.

As the use of natural gas increases globally, the need for methane gas leak detection is increasing as well. Leaving undetected or unattended, a leak in the natural gas pipeline or processing facility could pose serious explosion dangers as well as cause significant financial loss to natural gas facility operators, both due to the loss of valuable resources that can be turned into revenue and due to potential fines imposed by environmental protection agencies.

Traditional hydrocarbon gas detection usually employs either “point” sensors or “line” sensors. “Point” sensors are usually sensors that detect the concentration of a certain gas or several gas species by physical contact of the sensors with the target gases at the location where the sensors are installed. High sensitivity can usually be achieved using this technology.

However, these sensors can only detect gas by contact and only provide the gas concentration information at the point of detection. If these sensors are installed at fixed locations, they can only detect gas at certain points in location and cannot easily trace the source of gas leaks. Wind direction will also affect the detection significantly, because if the gas is blown away from the sensors, they will not be able to pick up any signal, even if they are right next to the leak sources. They also cannot easily quantify the amount of gas that has been emitted. If these sensors are used by operators for leak inspection, they will require operators to go near to a potential leak source to confirm the presence of gas. This will expose operators to potentially harmful and dangerous pollutants.

“Line” sensors usually utilize lasers to detect target gas species along the path that the laser beam travels. They usually can achieve high sensitivity as well, but target gases must be present along the laser path to be detected. Therefore, they cannot trace the leak sources and are highly affected by wind directions. Neither can they provide an estimate of the amount of gas that is leaking.

The 3rd generation gas detection technologies are usually image or video based. Most of them employ infrared detectors. Technologies within this category can be further divided into the following sub-categories: optical gas imaging (OGI) technology, multi-spectra technology, and hyperspectral technology.

OGI technology usually uses an infrared camera that is highly sensitive in a certain frequency band. They can detect gases that absorb infrared radiation in that frequency band. They usually do not involve complicated signal enhancement, and most of them do not provide leak rate quantification. Operators usually need to go through many hours of training to be qualified to use these cameras for leak detection and repair. Operator experience is also very important for the accurate identification of gas signals from infrared videos. To achieve high sensitivity, these cameras usually utilize cooled cameras and/or cold filters. This requires a cryocooler to be incorporated in the camera construction. The cooling devices usually involve moving components that wear out over time and/or helium gas that slowly escapes gas seals. Therefore, they have limited lifetime and require periodic maintenance or replacement. This usually increases the cost of these cameras significantly.

Multispectral and hyperspectral technologies both utilize multiple infrared sensors, and each sensor is spectrally filtered to only detect signals in a specific frequency band. The only difference is that multispectral technology usually uses a few sensors, whereas hyperspectral technology usually uses many sensors (could be tens or hundreds). They also often require cooling mechanisms to increase detection sensitivity. Many of them differentiate different gas species, while OGI cameras usually cannot differentiate different gas species unless filtered by a filter specifically designed for the detection of a certain gas species. However, the manufacturing cost of multi/hyper-spectral cameras is significantly higher than that of OGI cameras.

These 3rd generation technologies usually can provide a 2D presentation of the gas plumes that are being detected, thus enabling rapid leak source tracing. With advanced data analytics, they can also provide gas leak quantification, though most providers have not developed this feature yet due to its complexity.

Methane gas and some hydrocarbon gases absorb infrared radiation in the longwave infrared region (7-14 microns), and they can be viewed using a longwave infrared camera with sufficient sensitivity. This high sensitivity is usually achieved by cooling down the camera sensors, which increases the manufacturing and maintenance cost of such cameras drastically. In recent years, uncooled longwave infrared cameras with sufficiently high sensitivity became available and more affordable for civilian applications due to the lower cost and the ease of maintenance. However, the signal-to-noise ratio of the images captured for hydrocarbon gases by these cameras is usually low without any spectral filtering to reject unwanted signals from outside the absorption window of these hydrocarbon gases. The spectral filtering is mostly achieved through cooled filters that are inserted in front of or built in the camera lens. Such filters are usually expensive to manufacture, and cooling is usually required to reduce the thermal radiation coming from the filters themselves. Cooling mechanisms, as mentioned before, usually require refrigerants and/or moving parts and will increase the manufacturing cost and require frequent maintenance. Some filters (especially interference filters), even with cooling, also reflect the thermal radiation generated by the camera itself back into the camera, contributing to increased noise, degraded image quality, and reduced camera performance.

FIG. 1 shows a typical infrared image frame captured using an uncooled longwave infrared camera with a conventional bandpass filter at a short distance in front of it. The band pass filter transmits between 6.70 and 8.55 microns. The bright rectangle at the upper left corner of the frame shows the reflection of the infrared sensor core and is caused by the reflected infrared radiation generated by the sensor core.

The high cost of OGI and multi/hyper-spectral cameras, along with their limitations, have hindered the wide adoption of these technologies in industrial gas detection. Among the 3 sub-categories, OGI is currently the most utilized even though its cost is still high for most users.

Other current methane detection technologies include Differential Optical Absorption Spectroscopy (DOAS), Fourier Transform Infrared Spectroscopy (FTIR), and Tunable Diode Laser Absorption Spectroscopy (TDLAS).

DOAS typically relies on a broadband light source, which increases system complexity and power consumption. The need for an external light source limits its applicability in environments where installation and maintenance of the source is difficult. The system also requires a reflector to measure the gas concentration between the light source and the detector. This setup can be challenging to implement in open-field or remote locations where placing and aligning the reflector is impractical. The precision of DOAS measurements depends heavily on the stability of the broadband light source. Variations in light intensity can introduce measurement errors, requiring frequent calibration and maintenance. The accuracy of quantification relies on Beer's Law, which assumes a well-defined optical path length. Changes in atmospheric conditions, such as turbulence or variable gas distributions, can alter the effective path length and introduce uncertainties

FTIR typically uses Globar as its infrared light source, increasing power consumption and system complexity. The need for an external source also makes it less convenient for portable applications. The system uses a Michelson interferometer to achieve spectral detection, which allows for high precision but increases design complexity. Detection typically relies on a single-point detector, measuring a broad spectral range but not providing spatial information about gas distribution. In addition, most FTIR systems require cryogenically cooled detectors, adding to operational complexity and maintenance costs. Cooling requirements make the system bulky and less suitable for field deployment. Traditional FTIR systems are not imaging devices, making it difficult to directly visualize gas plumes. Some modern FTIR setups use scanning imagers or detector arrays to create gas distribution maps, but these images show the gas composition and concentration at each point, rather than the actual shape of the gas cloud. This limitation makes it difficult to intuitively identify the gas plume's shape and leakage source. The use of an interferometer introduces moving components, making the system highly susceptible to vibrations. Vibrations can degrade measurement accuracy and require careful environmental control. FTIR generates large amounts of spectral data, requiring high computational power for processing. The need for powerful computing hardware increases system costs and can slow down real-time analysis. Furthermore, due to its precision components, FTIR requires regular calibration and maintenance, leading to high operational costs. The overall system is expensive, making it less accessible for widespread use.

TDLAS systems typically need a reflector or a carefully aligned optical path between the laser source and detector. In outdoor environments, alignment can be challenging, and environmental factors (e.g., wind, temperature changes, or vibrations) can disrupt measurements. TDLAS provides a path-integrated concentration measurement rather than a localized point concentration. This means the measurement represents the total gas concentration along the laser beam path, making it less intuitive to interpret compared to imaging-based methods. Directly determining leakage rate or gas flow speed from TDLAS data is difficult without additional modeling or complementary measurements. While some scanning imaging systems exist, they operate slowly, limiting real-time tracking of gas movement. TDLAS does not provide a direct visual representation of the gas cloud or allow easy identification of the exact leak location. While less expensive than FTIR, TDLAS still requires high-quality laser sources and detectors, which contribute to the overall cost.

In addition, with the acceleration of industrialization, gas equipment systems are widely used in energy, chemical, petroleum and other fields due to their high efficiency and economy. At present, equipment leakage incidents occur from time to time. Equipment leakage problems not only cause economic losses but also may pose serious threats to the environment and human health. Therefore, it is particularly important to monitor equipment leakage in real time and take corresponding measures in time.

However, traditional equipment leak detection methods mainly rely on manual inspections and acoustic monitoring. Manual inspections usually take up a lot of time and human resources to cover a wide network of equipment, which results in relatively low detection efficiency. In addition, manual inspections are susceptible to fatigue, distraction, or professional skill levels of staff, which may lead to inaccurate or missed equipment leak detection results. Although the acoustic monitoring method significantly reduces the need for human labor and time expenditure, it may be affected by background noise in a noisy environment and cannot accurately distinguish different types of sound signals, reducing the accuracy of equipment leak detection. At the same time, the positioning accuracy of equipment leak points is limited.

### SUMMARY OF THE PRESENT INVENTION

The invention is advantageous in that it provides a hydrocarbon gas detection system to improve hydrocarbon gas detection and quantification performance of uncooled, longwave infrared cameras at a low cost and with ease of implementation. It would also make hydrocarbon gas detection, visualization, and quantification systems more cost effective to deploy in large scale.

Another advantage of the present invention is to provide a hydrocarbon gas detection system which is an OGI-based gas detection system that can detect methane and some other hydrocarbon gases, but at a significantly lower cost than the traditional OGI or multi/hyper-spectral cameras.

Another advantage of the present invention is to provide a hydrocarbon gas detection system which makes it easier or possible for uncooled longwave infrared cameras to visualize and quantify methane gas or other hydrocarbon gases present in the camera field of view.

Another advantage of the present invention is to provide a hydrocarbon gas detection system which is very easy to implement and involves no moving parts or refrigerants that would require frequent maintenance, significantly reducing maintenance costs.

Another advantage of the present invention is to provide a hydrocarbon gas detection system which reduces internal reflection of infrared radiation coming from the infrared cameras themselves, thus significantly reducing noise caused by stray light and improving gas detection and quantification performance.

Another advantage of the present invention is to provide a hydrocarbon gas detection system which makes continuous detection and quantification of methane or other hydrocarbon gas leaks possible.

Another advantage of the present invention is to provide a hydrocarbon gas detection system, wherein the cost of building such a system is significantly lower than any conventional systems currently available.

Additional advantages and features of the invention will become apparent from the description which follows and may be realized by means of the instrumentation and combinations particularly pointed out in the appended claims.

According to the present invention, the foregoing and other objects and advantages are attained by a hydrocarbon gas detection system, comprising:
a longwave infrared camera which comprises a camera sensor;
a spectral filter disposed in a light path of the camera sensor, wherein the spectral filter is made of a material selected from the group consisting of calcium fluoride, zinc sulfide, magnesium fluoride, and silicon; and
a computation unit arranged to process image data of the longwave infrared camera for the hydrocarbon gas detection.

According to an embodiment, the longwave infrared camera comprises a camera lens, wherein the spectral filter is positioned in front of the camera lens.

According to an embodiment, the longwave infrared camera comprises a camera lens, wherein the spectral filter is positioned between the camera lens and the camera sensor.

According to an embodiment, the spectral filter is functioning as a camera lens in front of the camera sensor.

According to an embodiment, the spectral filter has a thickness of 1-10 mm.

According to an embodiment, the spectral filter comprises a 5 mm calcium fluoride window.

According to an embodiment, the spectral filter comprises a 7 mm zinc sulfide window.

According to an embodiment, the spectral filter comprises a 2 mm magnesium fluoride window.

According to an embodiment, the spectral filter comprises a 5 mm silicon window.

According to an embodiment, a visual camera is connected with the computation unit.

According to an embodiment, the longwave infrared camera further comprises a camera shell which comprises a shield which is positioned above the camera lens.

According to an embodiment, the longwave infrared camera further comprises a germanium window which is positioned in front of the spectral filter.

According to an embodiment, a sapphire window is positioned in front of the visual camera.

According to an embodiment, the hydrocarbon gas is selected from the group consisting of methane, ethane, propane, butane, and propene.

According to an embodiment, the hydrocarbon gas is methane.

According to one embodiment, the longwave infrared camera is used to collect infrared monitoring video of a monitored equipment, and the computation unit comprises a data processor. The data processor is used to process the infrared monitoring video to obtain monitoring results, and the monitoring results are the location and gas flow data of an equipment leakage point, wherein the data processor comprises:

a moving object shielding module which is used for shielding moving objects in each infrared image frame in an infrared surveillance video to obtain a shielded infrared surveillance video;
an infrared image frame normalization module which is used for normalizing each infrared image frame in the infrared surveillance video after the shielding process to obtain a normalized infrared surveillance video;
a morphological processing module which is used for performing morphological processing on each infrared image frame in the normalized infrared surveillance video to obtain a morphologically processed infrared surveillance video;
a threshold binarization module which is used for performing a threshold-based binarization process on each infrared image frame in the infrared surveillance video after the morphological process to obtain a binarized infrared surveillance video;
a contour extraction module which is used for performing contour extraction on each infrared image frame in the infrared monitoring video after the binarization process to obtain an infrared monitoring video of an air mass contour; and
an equipment leakage point location detection module which is used to determine location data of the equipment leakage point based on the infrared monitoring video of the air mass contour.

According to one embodiment, the equipment leakage point location detection module comprises:
an optical flow algorithm processing unit which is used to process the infrared monitoring video of the air mass contour using an optical flow algorithm to obtain a set of pixel optical flow feature vectors;
a semantic association enhancement unit configured to perform semantic association enhancement on each pixel optical flow feature vector in the set of pixel optical flow feature vectors based on feature energy level measurement associated radiation to obtain a set of enhanced pixel optical flow feature vectors;
a feature aggregation unit which is used for inputting the set of enhanced pixel optical flow feature vectors into a feature aggregation network based on feature local energy distribution gating to obtain an air mass motion optical flow aggregation representation vector;
a decoding unit which is used for inputting the air mass motion optical flow aggregation representation vector into a leak source locator based on a decoder to obtain the position data of the equipment leak point.

According to another aspect, the present invention provides a methane gas detection system, comprising:
a longwave infrared camera which comprises a camera sensor;
a spectral filter which is a calcium fluoride window disposed in a light path of the camera sensor; and
a computation unit arranged to process image data of the longwave infrared camera for the methane gas detection.

According to an embodiment, the camera sensor and the calcium fluoride window are configured to allow light transmission between 7.5 microns and 8.5 microns.

According to another aspect, the present invention provides a camera arrangement for methane gas detection comprising:
a longwave infrared camera which comprises a camera sensor; and
a spectral filter which is a calcium fluoride window disposed in a light path of the camera sensor.

### BRIEF DESCRIPTION OF THE DRAWINGS

FIG. 1 is an infrared image showing the reflection of the camera sensor core, captured using an uncooled longwave infrared camera with a conventional bandpass filter at a short distance in front of the camera;

FIG. 2 is an overlay of a longwave infrared camera's spectral response curve, methane gas absorption spectrum, and the transmission profile of a 5-mm thick calcium fluoride window;

FIG. 3 is a schematic diagram showing the setup for methane or other hydrocarbon gas detection and quantification;

FIG. 4 is a schematic diagram showing a first alternative setup for methane or other hydrocarbon gas detection and quantification;

FIG. 5 is a schematic diagram showing a second alternative setup for methane or other hydrocarbon gas detection and quantification;

FIG. 6 is an overlay of the transmission profiles for a 7 mm thick zinc sulfide window, a 2 mm thick magnesium fluoride window, and a 5 mm thick uncoated silicon window;

FIG. 7 is an overlay of the relative absorption spectra of ethane, propane, butane, and propene;

FIG. 8 shows a picture of an explosion-proof camera;

FIG. 9 shows a block diagram of the explosion-proof camera of FIG. 8;

FIG. 10 is a schematic diagram illustrating a structure of an online gas leakage monitoring device in an embodiment of the present application;

FIG. 11 is a schematic diagram illustrating a structure of a data processor equipped with the online gas leakage monitoring device in the above embodiment of the present application;

FIG. 12 is a schematic diagram illustrating a structure of an equipment leakage point location detection module of the online gas leakage monitoring device in the above embodiment of the present application;

FIG. 13 is a flow chart of an online monitoring method for equipment gas leakage in the above embodiment of the present application;

FIG. 14 is a schematic view illustrating black smoke detection in the online monitoring method for equipment gas leakage in the above embodiment of the present application;

FIG. 15 illustrates an application scenario diagram of the equipment gas leakage online monitoring method in the above embodiment of the present application;

FIG. 16 is a block diagram of the computation unit and network interface of the diagram of FIG. 9; and

FIG. 17 is a flowchart summarizing the operation of the computation unit of FIG. 16.

### DETAILED DESCRIPTION OF THE PREFERRED EMBODIMENT

The following description is disclosed to enable any person skilled in the art to make and use the present invention. Preferred embodiments are provided in the following description only as examples. Modifications will be apparent to those skilled in the art. The general principles defined in the following description would be applied to other embodiments, alternatives, modifications, equivalents, and applications without departing from the spirit and scope of the present invention.

The present invention overcomes the problems associated with the prior art, by providing low-cost infrared filtering setup for continuous methane or other hydrocarbon gas detection and quantification using longwave infrared cameras. In the following description, numerous specific details are set forth (e.g., material types, computation steps, etc.) in order to provide a thorough understanding of the invention. Those skilled in the art will recognize, however, that the invention may be practiced apart from these specific details. In other instances, details of well-known photography practices (e.g. camera setup, assembly, etc.) and components have been omitted, so as not to unnecessarily obscure the present invention.

This invention provides a novel scheme of spectral filtering for uncooled longwave infrared cameras, which achieves acceptable detection and quantification of methane or other hydrocarbon gases with significantly reduced cost and without the need for frequent maintenance.

Specifically, the present invention provides a hydrocarbon gas detection system which comprises a longwave infrared camera 100, a spectral filter 200 disposed in a light path of the longwave infrared camera 100, and a computation unit 900 for processing image data from the longwave infrared camera 100.

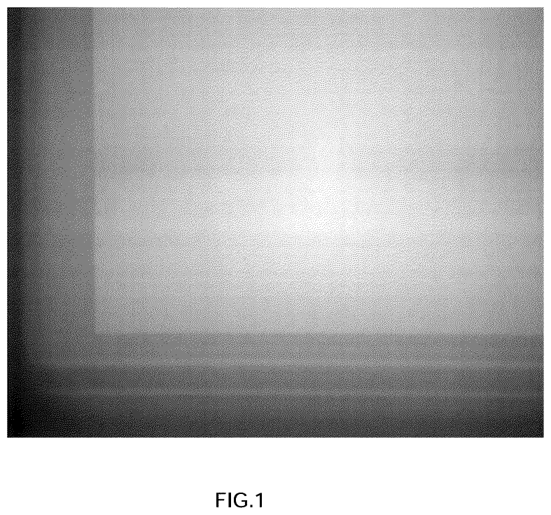

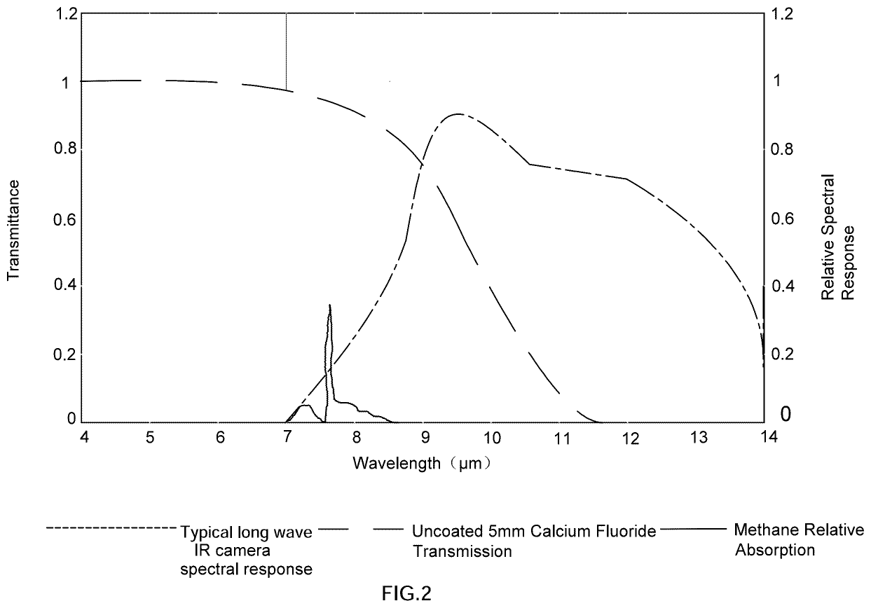

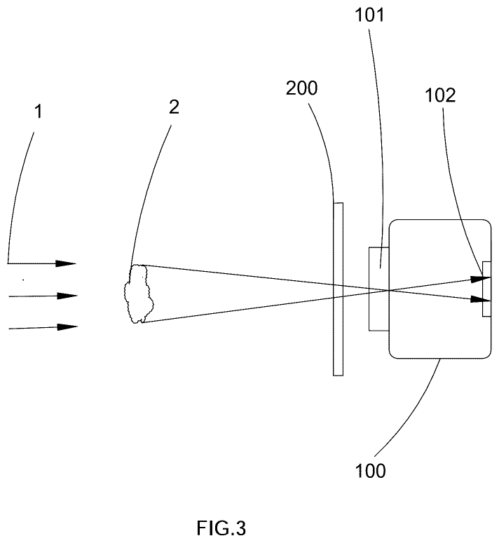

A window of an uncoated calcium fluoride or other suitable material with a certain thickness is used as the spectral filter 200, as shown in FIG. 3. Calcium fluoride transmits most of the infrared radiation shorter than 8.5 microns in wavelength. As the thickness of the calcium fluoride window increases, the transmittance of calcium fluoride drops sharply above 8.5 microns (see FIG. 2, uncoated 5 mm calcium fluoride transmission). Because most longwave infrared camera sensors 102 do not have a response below 7.5 microns (see FIG. 2, typical long wave IR camera spectral response), the combination of these two will achieve an equivalent spectral filtering that allows transmission between 7.5 and 8.5 microns. This transmission window encompasses most of the absorption signatures of methane gas (see FIG. 2, methane relative absorption) and some other hydrocarbon gases in the longwave infrared region. Besides that, calcium fluoride absorbs infrared radiation strongly at wavelengths longer than 8.5 microns. Therefore, the calcium fluoride windows will have minimal reflection of the thermal radiation in the wavelength range longer than 8.5 microns generated by the camera sensor core itself. This further reduces the noise contributed by filter reflection. Even though the calcium fluoride window itself may generate some thermal radiation, its contribution is much less than the reflection by conventional interference band pass filters. Infrared images acquired with calcium fluoride window as the filter do not show the reflection of the camera sensor radiation as the images acquired with a conventional filter do (FIG. 1). This setup can lead to improved methane gas detection performance over setups without any spectral filtering. The improved methane detection performance will also make gas leak quantification easier because of improved signal to noise ratio. The cost of manufacturing for this setup is significantly lower than that of cooled filters or built-in filters and will allow large scale production.

One embodiment of this setup is shown in FIG. 3, the longwave infrared camera 100 comprises a camera lens 101 and a camera sensor 102, the spectral filter 200 which is a calcium fluoride window of 5 mm thickness is placed in front of the camera lens 101 of the uncooled longwave infrared camera 100. When methane or other hydrocarbon gas clouds are present in the camera field of view, the background infrared radiation 1 passes through the gas cloud 2, and portions of the radiation are absorbed by the gas cloud 2. The infrared radiation then passes through the spectral filter 200 which is the calcium fluoride window and filters out the long wavelength portion of the infrared radiation. The remaining infrared radiation then passes through the camera lens 101 and is projected onto the camera sensor 102 to form images. The combination of the calcium fluoride window and the spectral response of the camera core naturally forms a “band pass filter” that only allows infrared radiation in the range from 7 microns to 11 microns to pass through to the camera sensor 102. This prevents infrared radiation outside this spectral window from passing through. Besides that, since calcium fluoride window “filters” infrared radiation through absorption, the infrared radiation generated by the camera sensor 102 will be absorbed by the calcium fluoride window instead of being reflected into the camera sensor 102. This further reduces noise. With this setup, when the hydrocarbon gas detection system is used as methane gas detection system, methane gas present in the camera field of view (FOV) will cause a larger drop (if methane gas is colder than the background) or increase (if methane gas is warmer than the background) in radiation received by the camera pixels that correspond to the methane gas cloud, thus increasing the contrast between areas with and without methane gas. This improves methane gas detection and quantification performance compared to a setup without spectral filtering.

By leveraging the spectral absorption properties of methane and hydrocarbon gases, the system enhances visibility of gas cloud 2 within the camera's field of view. The contrast between areas with and without methane gas is significantly increased due to selective absorption, making gas detection more precise and reliable. The system is effective regardless of whether the gas is warmer or colder than the background, ensuring robust detection in various environmental conditions.

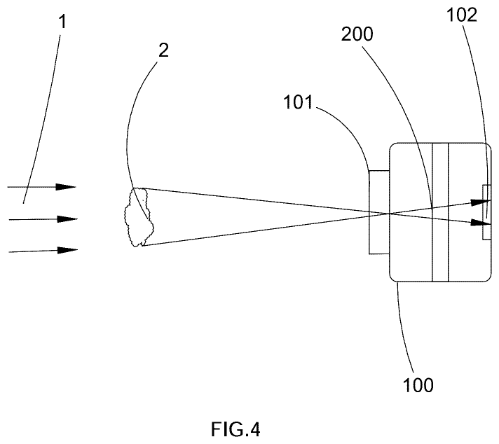

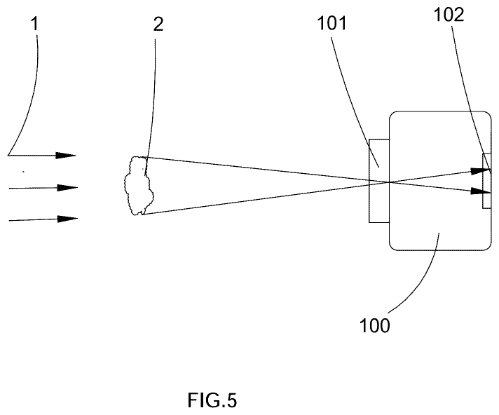

Other embodiments of this setup include building a calcium fluoride window inside the camera lens or right in front of the camera sensor or using calcium fluoride as the lens material. As shown in FIG. 4, the spectral filter 200 is arranged between the camera lens 101 and the camera sensor 102. Accordingly, the spectral filter 200 can be attached to the rear side of the camera lens 101, the front side of the camera sensor 102, or is positioned between the camera lens 101 and the camera sensor 102 apart from the camera lens 101 and the camera sensor 102. As shown in FIG. 5, the camera lens 101 is made of calcium fluoride, so as to function as the spectral filter 200.

When calcium fluoride is placed inside the optical path, whether between the camera lens 101 and the camera sensor 102, or as the camera lens 101 itself, it absorbs long wavelength infrared radiation rather than reflecting it. This further reduces unwanted thermal reflections from the camera sensor 102, lowering background noise and improving image contrast for gas detection. Compared to an externally mounted calcium fluoride window, these internal configurations offer a more controlled optical environment, minimizing stray light reflections from ambient infrared sources.

One thing worth mentioning is that FIG. 2 uses a 5 mm thick calcium fluoride window as an example to illustrate the working principle of this setup. The thickness of the window can be varied to further narrow down or broaden the transmission window of this setup and thus changing the detection performance. One drawback of narrowing down the transmission window too much using thicker calcium fluoride windows is that its overall transmittance at the methane absorption band also decreases, thus reducing the total radiation passing into the camera. This may adversely affect the performance. The best thickness of the window needs to be determined through experimentation.

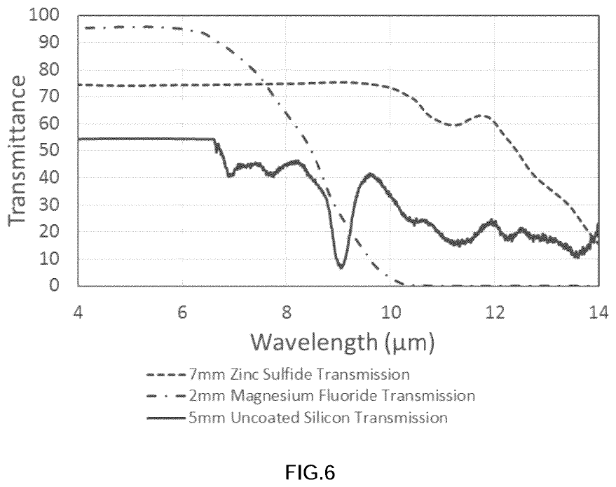

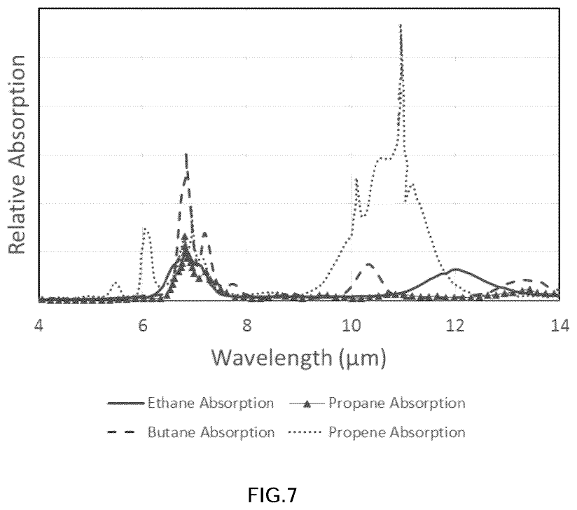

Another note is that calcium fluoride is not the only window material that can be used for this setup. Other materials such as zinc sulfide, magnesium fluoride, or silicon could be used instead of calcium fluoride with careful selection of the window thickness (see FIG. 6 for an overlay of the transmission profiles for a 7 mm thick zinc sulfide window, a 2 mm thick magnesium fluoride window, and a 5 mm thick uncoated silicon window). Other hydrocarbon gases, such as ethane, propane, butane, propene (see FIG. 7 for the relative absorption spectra of these gases), and gasoline can also be detected using this setup with proper selection of window material and thickness.

An example embodiment of the invention is that the hydrocarbon gas detection system can be embodied as a gas leak detection camera system that includes an edge-computing unit for fast on-board computation. More specifically, the hydrocarbon gas detection system comprises the uncooled longwave infrared camera 100, the spectral filter 200 which can be a select optical window installed in front of the infrared camera 100, a high-definition visual camera 300, the on-board computation unit 900 for data processing, and a network interface 912 that allows the system to be connected to the internet. A germanium window 104 can be installed in a camera shell 103 of the infrared camera 100 to protect the infrared camera 100 from the outside environment, while a sapphire window 301 can be arranged to protect the visual camera 300. Different window materials can be used as long as they allow optical signals to pass to the respective cameras with high transmittance.

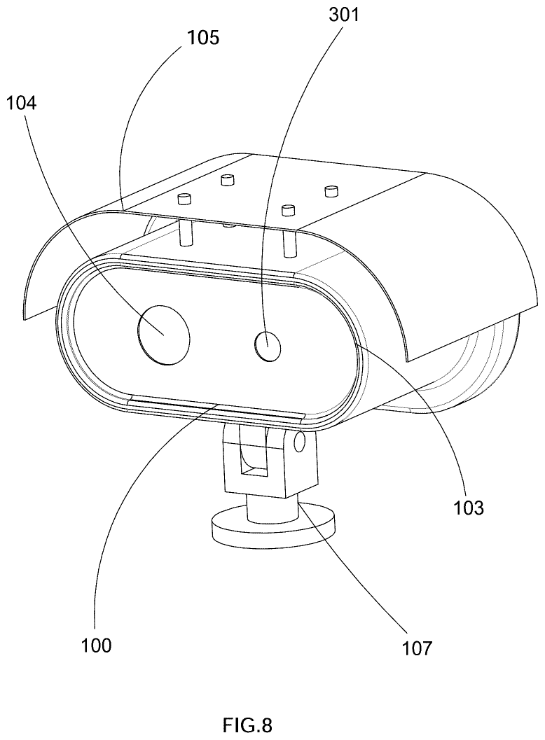

FIG. 8 presents a 3-D rendition of the explosion-proof camera shell 103. A non-explosion proof camera shell 103 can also be used for certain scenarios that do not require explosion-proof certificates. On top of the camera shell 103, there is a shield 105 to shield the unit from the sun, rain and snow. This not only prevents the camera windows from being blocked by rainwater or snow accumulated on them, it also helps with heat dissipation to keep the unit cool in the summer.

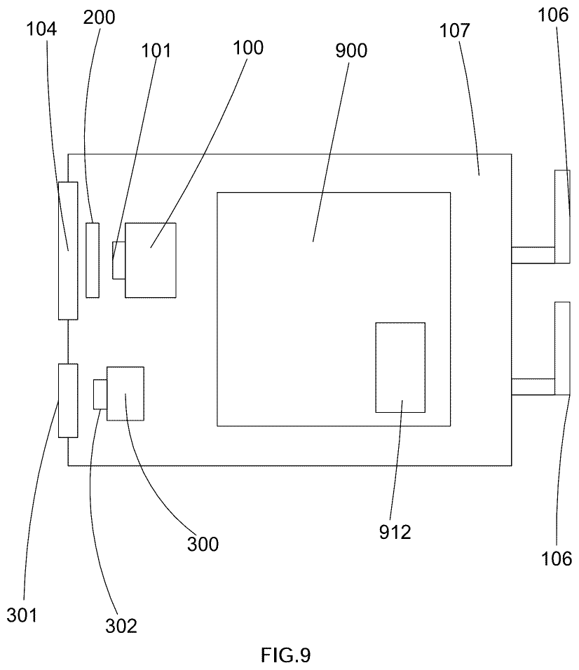

FIG. 9 is a block diagram showing the main components of the hydrocarbon gas detection system to include the germanium window 104, the sapphire window 301, the spectral filter 200 which can be embodied as the calcium fluoride window, the camera lens 101 of the infrared camera 100, a lens 302 of the visual camera 300, a computation unit 900, a network interface 912, antennas 106, and a camera base plate 107.

The computation/processing unit 800 used in the current implementation has a computing power of 472 GFLOPS (giga floating point operations per second). It also includes a 128-core GPU for computation intensive operations. Different data storage options can be incorporated to store detection data on the device in case that network connectivity is not available. The computation unit can be replaced with other compatible platforms. The network interface 912 allows LTE, Wi-Fi and ethernet connectivity options. The module can also provide global positioning (GPS) function if needed. In a slightly modified implementation, an external or cloud-based computation unit can also be used instead of a built-in computation unit. The built-in computation unit 900 has the advantage of fast computation that does not depend on network connectivity. A remote computation unit can offer potentially higher computation power for more computationally intensive operations.

In a slightly modified implementation, a remote power switch can be included in the setup to allow the infrared camera 100 to be disconnected from power briefly for remote trouble shooting purposes. Depending on the specific requirements of a facility, the power adapter can either be built in the camera shell 103 or be installed in an external electrical box. The base of the camera shell 103 is designed to rotate in both the horizontal direction and the vertical direction for easy adjustment of monitoring angles. The base can be installed either on a pole or on a mounting point at customer facilities. In a different implementation, a pan-tilt system (either external or built-in) can be included to allow remote control of the monitoring angle as well as the monitoring of multiple scenes using the same camera. If needed, a solar panel with a UPS (uninterruptible power supply) battery system can also be incorporated to provide power during power outages or for scenarios where the electric grid is not available.

In the present invention, the uncooled infrared camera 100 is utilized to reduce the manufacturing cost. The spectral filter 200 with a select transmission profile (calcium fluoride in this specific implementation) is used instead of a band-pass or cold filter in front of the infrared camera 100 to enhance the detection sensitivity for methane in the 7.5 micron to 8.5 micron wavelength band. The optical window can be replaced with other window materials to widen or narrow down the detection wavelength band to enhance or decrease the detection sensitivity of different hydrocarbon gases.

The infrared camera sensor 102 is sensitive in the 7.5 to 14 microns wavelength band. So, any gas that absorbs infrared radiation in this band can potentially be detected. However, this specific implementation uses a 5-mm thick calcium fluoride window to enhance the detection of methane gas. The infrared camera 100 captures infrared signals in the 7.5 to 8.5 microns wavelength band, in which methane has strong absorption. Depending on the temperature difference between methane gas and the background, the infrared camera pixels corresponding to the methane gas plumes will either appear darker (if methane gas temperature is lower than background temperature) or brighter (if methane gas temperature is higher than background temperature) than the pixels that correspond to the background of the gas plumes.

This will create a contrast between the gas plume pixels and the background pixels, thus enabling gas detection. The difference in brightness and the number of pixels associated with gas signals are also indirectly related to the amount of gas present in the camera field of view, thus enabling the quantification of gas that is being detected. Combined with the change of brightness and gas pixel numbers over time, the leak rate of gas can be estimated. This estimate can be calibrated against true leak rates during controlled gas release experiments to obtain parameters that can be used to predict gas leak rates.

Preferred thickness of the spectral filter 200 is 5-10 mm thick, which can be used to detect methane and hydrogen sulfide; when the thickness is 2 mm, it can be used to detect methane, butane, and ammonia; and when the thickness is 0.5 mm, it can detect methane, ammonia, ethane, and butane. Without calcium fluoride, it can be used to detect most hydrocarbons, hydrogen sulfide, and ammonia. However, when the spectral filter is not used or the spectral filter is very thin, the noise signal for methane and hydrogen sulfide detection will be relatively large.

In the longwave infrared camera's spectral response region (7.5 to 14 microns), the absorption peak of hydrogen sulfide is between 7 and 9.5 microns, while that of ammonia is between 8 and 13 microns and that of propylene is between 9.5 and 12 microns. Propylene can be detected when the thickness is less than 2 mm or there is no calcium fluoride filter.

In addition, with the advancement of sensor technology and image processing technology, leak detection systems based on video monitoring have gradually become an emerging solution. Among them, infrared imaging technology can use the radiation characteristics within the infrared spectrum to effectively monitor gas leaks and detect leak points under different environmental conditions. By capturing infrared images around the monitored equipment, the system can identify the characteristics of gas leaks and further extract the location data and gas flow data of the leak point through data processing algorithms.

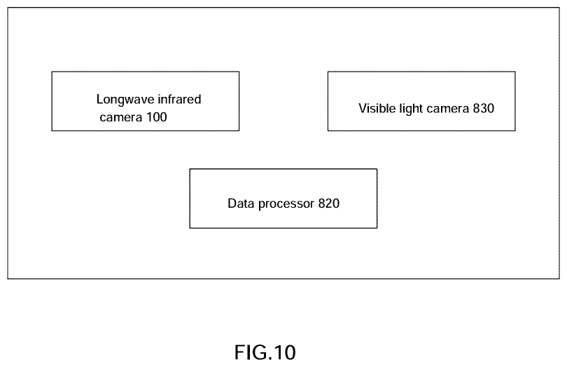

Based on this, in the technical solution of the present application, an optical device for online monitoring of equipment gas leakage is also proposed, as shown in FIG. 10. The optical device comprises a longwave infrared camera 100 and a data processor 820. The longwave infrared camera 100 is used to collect infrared monitoring videos of the monitored equipment, and the data processor 820 is used to process the infrared monitoring video to obtain monitoring results, and the monitoring results are location and gas flow data of the equipment leakage point.

In some optional embodiments, a visible light camera 830 is further included, and the visible light camera 830 can further collect information about the environment and perform key image information fusion to facilitate further analysis and optimization of the collected information.

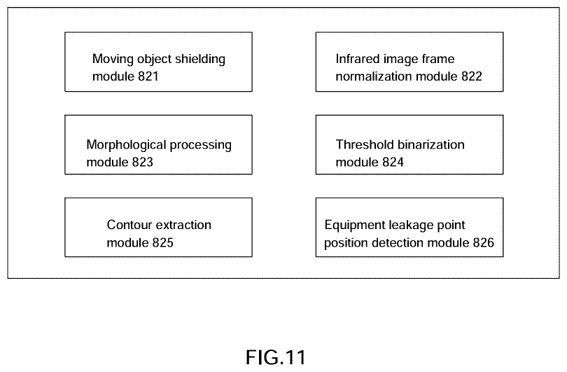

In the above mentioned optical device for online monitoring of equipment gas leakage, as shown in FIG. 11, the data processor 820 comprises: a moving object shielding module 821 which is used to shield the moving objects in each infrared image frame in the infrared monitoring video to obtain the infrared monitoring video after shielding; an infrared image frame normalization module 822 which is used to normalize each infrared image frame in the infrared monitoring video after shielding to obtain the infrared monitoring video after normalization; a morphological processing module 823 which is used to perform morphological processing on each infrared image frame in the infrared monitoring video after normalization to obtain the infrared monitoring video after morphological processing; a threshold binarization module 824 which is used to perform threshold-based binarization processing on each infrared image frame in the infrared monitoring video after morphological processing to obtain the infrared monitoring video after binarization processing; a contour extraction module 825 which is used to perform contour extraction on each infrared image frame in the infrared monitoring video after binarization processing to obtain an air mass contour infrared monitoring video; an equipment leakage point position detection module 826, which is used to determine the position data of the equipment leakage point based on the air mass contour infrared monitoring video.

In a specific example, the moving object shielding module 821 is used to employ a mixed Gaussian background modeling algorithm to perform statistical analysis on the pixel brightness values of each infrared image frame, and shield pixels that exceed the normal brightness distribution range to obtain the infrared surveillance video after shielding.

In a specific example, the infrared image frame normalization module 822 is used to perform normalization processing on each infrared image frame in the infrared surveillance video after the shielding processing according to the following normalization processing formula to obtain the normalized infrared surveillance video; wherein the normalization processing formula is:

$${ir}^{′} = \frac{( ir - min ( ir ) )}{( max ( ir ) - min ( ir ) )}$$

In the formula, ir is the respective infrared image frames, min (ir) denotes the minimum value of the respective infrared image frames, max (ir) denotes the maximum value of the respective infrared image frames, and ir is the respective infrared image frames in the normalized infrared surveillance video.

In a specific example, the contour extraction module 825 is used to employ the findContour function to perform contour extraction on each infrared image frame in the binarized infrared monitoring video to obtain the air mass contour infrared monitoring video.

After performing moving object shielding, normalization processing, morphological processing, binarization processing and contour extraction on each infrared image frame in the collected infrared monitoring video, the necessary clarity and accuracy are provided for the subsequent equipment leakage monitoring and leakage point localization tasks. The positioning step is the key link in the entire monitoring process. Only by accurately identifying equipment leakage and determining the leakage location can the effectiveness and reliability of the system be ensured. This will in turn help timely measures to be taken to repair the leaks and prevent accidents and other negative effects on the environment and economy.

In a specific example, the morphological processing module 823 is used to perform morphological processing on each infrared image frame in the normalized infrared surveillance video to obtain the morphologically processed infrared surveillance video; a feature point extraction function can be added to extract and describe key feature points of the video frame after morphological processing. It further includes being responsible for performing the following steps: feature point detection, applying feature point detection algorithms (such as ORB, SIFT, SURF, etc.) on the morphologically processed image to identify key feature points in the image; feature description, generating descriptors for each detected feature point, which can represent the local characteristics of the feature point and are used in subsequent matching or analysis processes; feature screening, screening out the most significant or stable feature points according to specific criteria (such as the response strength of the feature point, the quality of the corner point, etc.) to improve the accuracy and robustness of subsequent processing; feature storage/transmission, storing or transmitting the extracted feature points and their descriptors to the next processing stage for further analysis or matching; visualization of feature points, if necessary, feature points can be marked on the image for easy debugging and visualization.

In a specific example, the morphological processing module 823 collects image information from a longwave infrared camera 100 and/or a visible light camera 830 and identifies positioning points in specific areas of the equipment. In most scenarios, the areas where equipment is prone to leakage mainly come from the gaskets or welds of containers or pipes, equipment outlets or inlets, and bends or corners with low structural strength. These areas are often concentrated at the junction of two materials or components. By using the morphological processing module 823 to perform the feature point extraction function, information about the leakage-prone areas of the equipment is collected in advance, and key leakage source monitoring is performed, which can further reduce the demand for image processing computing power, reduce the probability of misjudgment, and improve recognition accuracy.

In some specific examples, after the morphological processing module 823 collects image information from the longwave infrared camera 100 and/or the visible light camera 830, it identifies the leak-prone area and performs image segmentation for obtaining the complete acquisition area, focusing on image processing and algorithm analysis for segmented image information with leak-prone areas. For the rest, after the leak source monitoring confirms the occurrence of a leak event, image processing and algorithm analysis are performed on the full-frame or adjacent segmented image information to improve the rationality of computing power allocation and reduce the background data processing pressure.

Furthermore, in the step of determining the location data of the equipment leakage point based on the infrared monitoring video of the air mass contour, the technical concept of the present application is to analyze the infrared monitoring video of the air mass contour by introducing an image processing and analysis algorithm based on deep learning at the back end, so as to learn and characterize the pixel optical flow characteristics between video image frames, thereby obtaining an optical flow aggregation representation of the air mass movement information, so as to locate the source of the leakage and obtain the leakage point location data. In this way, more intelligent equipment leakage monitoring and leakage point localization can be achieved, so that when equipment leakage occurs, a rapid response can be made according to the location of the leakage point, providing safety protection for enterprises and reducing potential environmental risks and economic losses.

Specifically, in the technical solution of the present application, the infrared monitoring video of the air mass contour is processed by using an optical flow algorithm to obtain a set of pixel optical flow feature vectors. In particular, in a specific example of the present application, the Farneback optical flow method or the Lucas-Kanade optical flow method can be used to calculate the motion vector between adjacent frames in the infrared monitoring video of the air mass contour to provide the motion direction and speed of each pixel. This is crucial for detecting the movement of air masses during gas leaks, because the diffusion of leaking gas is usually accompanied by obvious motion characteristics. By analyzing this motion information, the diffusion pattern and dynamic changes of the gas can be better understood, thereby improving the accuracy of real-time leak detection.

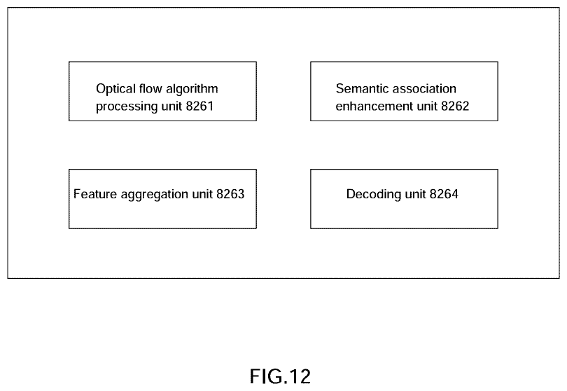

Correspondingly, as shown in FIG. 12, the equipment leakage point location detection module 826 comprises: an optical flow algorithm processing unit 8261 which uses the optical flow algorithm to process the air mass contour infrared monitoring video to obtain a set of pixel optical flow feature vectors; a semantic association enhancement unit 8262 which is used to perform semantic association enhancement on each pixel optical flow feature vector in the set of pixel optical flow feature vectors based on feature energy level metric associated radiation to obtain a set of enhanced pixel optical flow feature vectors; a feature aggregation unit 8263 which is used to input the set of enhanced pixel optical flow feature vectors into a feature aggregation network based on feature local energy distribution gating to obtain an air mass movement optical flow aggregation representation vector; a decoding unit 8264 which is used to input the air mass movement optical flow aggregation representation vector into a decoder-based leak source locator to obtain the location data of the equipment leakage point.

Then, since each pixel optical flow feature vector in the set of pixel optical flow feature vectors represents the pixel optical flow features between each group of adjacent frames, it reflects the movement direction and speed of each pixel between adjacent frames, and this information is crucial for equipment gas leakage monitoring and leakage point location positioning. However, in the process of equipment gas leakage monitoring and leakage point location positioning, the complexity of the environment may cause a large amount of irrelevant information to be mixed into the pixel optical flow feature vector. At the same time, the pixel optical flow features between different adjacent frames will have different importance and contribution to the subsequent leakage point identification and localization tasks. Based on this, in the technical solution of the present application, each pixel optical flow feature vector in the set of pixel optical flow feature vectors is further semantically enhanced based on the feature energy level measurement associated radiation to obtain a set of enhanced pixel optical flow feature vectors. Through the semantic association enhancement processing based on the feature energy level measurement associated radiation, the focus can be on those features that truly reflect the movement of equipment leakage gas through detailed feature energy level analysis and fine-grained semantic association enhancement, which significantly improves the expressiveness of the pixel optical flow semantic features between adjacent frames and the semantic understanding ability of the model, thereby improving the accuracy of leakage point identification and localization, and reducing false alarms and missed alarms.

Specifically, the processing steps for semantic association enhancement based on feature energy level metric associated radiation are as follows: first, the feature energy level coefficients are calculated for the set of pixel optical flow feature vectors to quantify the energy distribution of each pixel optical flow feature vector. In the technical solution of the present application, the feature energy level coefficients are related to the statistical characteristics of the scale and feature distribution of each pixel optical flow feature vector, which is used to represent the semantic information content density of each pixel optical flow feature vector itself and its influence on the semantic information of other pixel optical flow feature vectors in the surrounding neighborhood. Furthermore, one-dimensional convolutional coding is applied to capture the local dependencies in the feature energy level coefficient sequence of pixel optical flow semantics, and point convolution coding is used to further enhance the expression ability of spatial features. On this basis, a function-based probabilistic mapping is used to generate a pixel optical flow semantic feature energy level radiation associated weight vector to achieve adaptive weighting of feature energy levels. In particular, the pixel optical flow semantic feature energy level radiation association weight vector is used as the weight, and the feature vector sequence is weighted and residual processed to obtain the set of enhanced pixel optical flow feature vectors. This process not only strengthens the semantic association in the set of pixel optical flow feature vectors but also improves the significance of the features and enhances the model's ability to capture key pixel optical flow semantic information. Therefore, by dynamically adjusting feature weights and strengthening feature representation, the model can more flexibly cope with the diversity and complexity of different equipment leakage environments, thereby better locating the leakage point in various equipment leakage environments.

Correspondingly, the semantic association strengthening unit 8262 comprises: a feature energy level coefficient calculation subunit which is used to calculate the feature energy level coefficient of each pixel optical flow feature vector in the set of pixel optical flow feature vectors to obtain a sequence of pixel optical flow feature energy level coefficients; a coefficient arrangement subunit which is used to arrange the sequence of pixel optical flow feature energy level coefficients into a pixel optical flow feature energy level coefficient input vector; a one-dimensional convolution encoding subunit which is used to perform one-dimensional convolution encoding on the pixel optical flow feature energy level coefficient input vector to obtain a pixel optical flow feature energy level radiation association vector; and a point convolution encoding subunit which is configured to perform point convolution encoding on the pixel optical flow feature energy level radiation association vector to obtain a pixel optical flow feature energy level radiation convolution association vector; a probabilistic mapping subunit which is used to input the pixel optical flow feature energy level radiation convolution association vector into a sigmoid function for probabilistic mapping to obtain a pixel optical flow feature energy level radiation association weight vector; an enhancement subunit which is used to use the characteristic value of each position in the pixel optical flow feature energy level radiation association weight vector as the weight value, perform vector-by-vector point multiplication on the set of pixel optical flow feature vectors by position, and add the set of pixel optical flow feature vectors to obtain the set of enhanced pixel optical flow feature vectors.

The characteristic energy level coefficient calculation subunit is used to: extract the characteristic maximum value of each position in the pixel optical flow feature vector to obtain the pixel optical flow feature maximum value; respectively calculate the mean and variance of the pixel optical flow feature vector to obtain the pixel optical flow feature mean and the pixel optical flow feature variance; multiply the value obtained by adding the pixel optical flow feature variance and the preset hyperparameter by four to obtain the first energy level coefficient of the pixel optical flow feature; calculate the square of the difference between the pixel optical flow feature maximum value and the pixel optical flow feature mean to obtain the pixel optical flow feature difference value; add the modulated pixel optical flow feature variance obtained by multiplying the pixel optical flow feature variance by two, the value obtained by multiplying the preset hyperparameter by two, and the pixel optical flow feature difference value to obtain the second energy level coefficient of the pixel optical flow feature; divide the first energy level coefficient of the pixel optical flow feature by the second energy level coefficient of the pixel optical flow feature to obtain the pixel optical flow feature energy level coefficient.

In a specific example, the semantic association enhancement unit 8262 is used to: perform semantic association enhancement based on feature energy level measurement associated radiation on each pixel optical flow feature vector in the set of pixel optical flow feature vectors using the following feature association radiation enhancement formula to obtain the set of enhanced pixel optical flow feature vectors; wherein the feature association radiation enhancement formula is:

$$\begin{matrix}X = \{ {x}_{1} , {x}_{2} , … , {x}_{k} , … , {x}_{n} \} \\ {e}_{i} = \frac{4 ( {σ}_{i}^{2} + ε )}{{( max ( {x}_{i} ) - {μ}_{i} )}^{2} + 2 {σ}_{i}^{2} + 2 ε} \\ {V}_{e} = ( {e}_{1} ; {e}_{2} ; … ; {e}_{k} ; … ; {e}_{n} ) \\ {V}_{f} = C o n {v}_{1 \times l} ( {V}_{e} ) \\ {V}_{c} = Sigmoid ( {Conv}_{1 \times 1} ( {V}_{f} ) ) \\ {X}^{′} = X ⊙ {V}_{c} + X\end{matrix}$$

In the formulas, X denotes the set of pixel optical flow feature vectors, xₖ and xₙ are the k-th pixel optical flow feature vector and the n-th pixel optical flow feature vector in the set of pixel optical flow feature vectors, n denotes the number of feature vectors in the set of pixel optical flow feature vectors, μᵢ and σ²ᵢ are respectively mean and variance of the i-th pixel optical flow feature in the set of pixel optical flow feature vectors, max(xᵢ) denotes the characteristic maximum value in the i-th pixel optical flow feature vector, ε is a preset hyperparameter, eᵢ is the characteristic energy level coefficient of the i-th pixel optical flow feature vector, eₖ and eₙ are respectively the characteristic energy level coefficients of the k-th pixel optical flow feature vector and the n-th pixel optical flow feature vector, Ve is the pixel optical flow feature energy level coefficient input vector, Conv_{1×l} is a one-dimensional convolutional code, l is the scale of the one-dimensional convolution kernel, V_{f} is the pixel optical flow feature energy level radiation association vector, Conv_{1×1}(·) is a point convolutional code, Sigmoid is a Sigmoid function, V_{c} is the pixel optical flow feature energy level radiation association weight vector, ⊙ represents point multiplication by position, and X′ is the set of enhanced pixel optical flow feature vectors.

It should be understandable that since each enhanced pixel optical flow feature vector in the set of enhanced pixel optical flow feature vectors respectively contains the waveform semantic feature information of the pixel optical flow semantics of each two adjacent key frames after being expressed through key feature enhancement, in the task of equipment leakage point identification and position positioning, a single enhanced pixel optical flow feature vector is not sufficient to fully describe the temporal changes of the pixel optical flow semantics and the temporal movement of the equipment leakage gas, making it difficult to effectively identify and detect the subsequent positioning of the equipment leakage point. Based on this, in the technical solution of the present application, the set of enhanced pixel optical flow feature vectors is further input into a feature aggregation network based on feature local energy distribution gating to obtain an air mass movement optical flow aggregation representation vector. It should be understood that the feature aggregation network based on feature local energy distribution gating can utilize the feature energy local saliency gating mechanism to dynamically adjust the weights of different pixel optical flow features in the aggregation process, so that the model can focus on those pixel optical flow features with higher energy and more contribution to equipment leakage point detection and positioning tasks. This mechanism can filter out noise and redundant information and improve the effectiveness of features. Therefore, through the processing of the feature aggregation network based on feature local energy distribution gating, the local energy distribution of each pixel optical flow feature can be analyzed during the process of aggregating different pixel optical flow features, which helps to identify and strengthen those features with significant energy distribution in the local neighborhood, thereby improving the model's sensitivity to local changes. The analysis of this local energy distribution helps to identify the dynamic changes of key pixel optical flow features, which may be related to the movement and propagation information of the leaking gas and are of great significance for the task of locating the source of the leak. Then, using the gating function and mask module, the saliency of different pixel optical flow features can be dynamically adjusted. This adaptive screening mechanism allows the model to dynamically adjust its focus based on the optical flow information of air mass movement, thereby more effectively highlighting important pixel optical flow semantics and suppressing unimportant features in the aggregation results of pixel optical flow features to form an optical flow aggregation representation of air mass movement, which helps the model to more accurately identify and locate equipment leakage points.

Accordingly, the feature aggregation unit 8263 includes: a coefficient acquisition subunit which is used to determine the characteristic energy level coefficients of each enhanced pixel optical flow feature vector in the set of enhanced pixel optical flow feature vectors based on the maximum value, minimum value, mean value and variance of each enhanced pixel optical flow feature vector to obtain a sequence of pixel optical flow characteristic energy level coefficients; a local neighborhood mean calculation subunit which is used to determine the scale of the local neighborhood of the pixel optical flow, and use the scale of the local neighborhood of the pixel optical flow as the mean calculation range to calculate each of the pixel optical flow characteristic energy level coefficients to obtain a sequence of pixel optical flow feature energy level significance descriptors; a mask subunit which is used to input the sequence of pixel optical flow feature energy level significance descriptors into a mask module based on a gating function to obtain a sequence of mask-gated probabilistic pixel optical flow feature energy level significance descriptors; a position-weighted sum subunit which is used to use the sequence of mask-gated probabilistic pixel optical flow feature energy level significance descriptors as a sequence of weights, calculate the position-weighted sum of the set of enhanced pixel optical flow feature vectors to obtain the air mass motion optical flow aggregation representation vector.

The coefficient acquisition subunit includes: a multi-item calculation secondary subunit which is used to calculate the maximum value, minimum value, average value and variance of the enhanced pixel optical flow feature vector to obtain the pixel optical flow maximum value, pixel optical flow minimum value, pixel optical flow average value and pixel optical flow variance; a first statistical factor calculation secondary subunit which is used to calculate the sum of the pixel optical flow variance and the hyperparameter to obtain the first pixel optical flow local energy statistical factor; a maximum difference calculation secondary subunit which is used to calculate the difference between the pixel optical flow maximum value and the pixel optical flow average value to obtain the pixel optical flow maximum deviation value; a minimum difference calculation secondary subunit which is used to calculate the difference between the pixel optical flow minimum value and the pixel optical flow average value to obtain the pixel optical flow minimum deviation value; a second statistical factor calculation secondary subunit which is used to calculate the square sum of the pixel optical flow maximum deviation value and the pixel optical flow minimum deviation value and then add it to the hyperparameter to obtain the second pixel optical flow local energy statistical factor; a division operation secondary subunit which is used to calculate the division between the first pixel optical flow local energy statistical factor and the second pixel optical flow local energy statistical factor to obtain the pixel optical flow characteristic energy level coefficient.

The mask subunit is used to: use the negative number of each pixel optical flow feature energy level saliency descriptor in the sequence of pixel optical flow feature energy level saliency descriptors as the exponential power, calculate the exponential function value with the natural constant e as the base to obtain a sequence of pixel optical flow feature energy level class support saliency descriptors; calculate the positional sum between the sequence of pixel optical flow feature energy level class support saliency descriptors and the constant 1 to obtain a sequence of linear modulation pixel optical flow feature energy level class support saliency descriptors; calculate the reciprocal of each linear modulation pixel optical flow feature energy level class support saliency descriptor in the sequence of linear modulation pixel optical flow feature energy level class support saliency descriptors to obtain a pixel optical flow gated probabilistic feature energy level saliency descriptor; perform masking processing on each pixel optical flow gated probabilistic feature energy level significance descriptor in the sequence of pixel optical flow gated probabilistic feature energy level significance descriptors to obtain the sequence of masked gated probabilistic pixel optical flow feature energy level significance descriptors; wherein, performing masking processing on each pixel optical flow gated probabilistic feature energy level significance descriptor in the sequence of pixel optical flow gated probabilistic feature energy level significance descriptors to obtain the sequence of masked gated probabilistic pixel optical flow feature energy level significance descriptors comprises: in response to the pixel optical flow gated probabilistic feature energy level significance descriptor being greater than a predetermined threshold, taking the original value of the pixel optical flow gated probabilistic feature energy level significance descriptor, otherwise setting it to 0.

In a specific example, the feature aggregation unit 8263 is used to input the set of enhanced pixel optical flow feature vectors into the feature aggregation network based on feature local energy distribution gating to process it with the following feature aggregation formula to obtain the air mass motion optical flow aggregation representation vector; wherein the feature aggregation formula is:

$$\begin{matrix}{X}^{′} = \{ {x}_{1}^{′} , {x}_{2}^{′} , … , {x}_{k}^{′} , … , {x}_{n}^{′} \} \\ {a}_{i} = \frac{{σ}_{i}^{′ 2} + ε}{{( max ( {x}_{i}^{′} ) - {u}_{i}^{′} )}^{2} + {( min ( {x}_{i}^{′} ) - {u}_{i}^{′} )}^{2} + ϵ} \\ {a}_{c i} = \frac{1}{N u {m}_{r}} {\sum }_{q = 1}^{N u {m}_{r}} {a}_{q} \\ {w}_{i} = \frac{1}{1 + {e}^{- {a}_{ci}}} \\ {w}_{s i} = mask ( {w}_{i} ) \\ mask ( x ) = \{ \begin{matrix}{w}_{i} & {w}_{i} > θ \\ 0 & {w}_{i} \leq θ\end{matrix} \\ \begin{matrix}Y = \{ {y}_{1} , {y}_{2} , … , {y}_{k} , … , {y}_{n} \} , & {y}_{i} = {w}_{s i} \cdot {x}_{i}\end{matrix} \\ f = \frac{1}{n} {\sum }_{i = 1}^{n} {y}_{i}\end{matrix}$$

In the formulas, X′ is the set of enhanced pixel optical flow feature vectors, xᵢ′ is the i-th enhanced pixel optical flow feature vector in the set of enhanced pixel optical flow feature vectors, μᵢ′ is the mean of the i-th enhanced pixel optical flow feature vector, σᵢ′² is the variance of the i-th enhanced pixel optical flow feature vector, e is a hyperparameter, max(xᵢ′) denotes the maximum value in the i-th enhanced pixel optical flow feature vector, min(xᵢ′) denotes the minimum value in the i-th enhanced pixel optical flow feature vector, aᵢ is the characteristic energy level coefficient of the i-th enhanced pixel optical flow feature vector, Num denotes the number of characteristic energy coefficients in the local neighborhood centered on the characteristic energy level coefficient described by eᵢ, a_{q} is the enhanced characteristic energy level coefficient of the q-th pixel optical flow feature vector, a_{ci} is the characteristic energy level significance descriptor of the i-th enhanced pixel optical flow feature vector, wᵢ is the gated probabilistic feature energy level saliency descriptor of the i-th enhanced pixel optical flow feature vector, mask (·) is the masking operation, θ is a predetermined threshold, wₛᵢ is the masked gated probabilistic feature energy level significance descriptor of the i-th enhanced pixel optical flow feature vector, yₛᵢ the significant enhanced pixel optical flow feature vector corresponding to the i-th enhanced pixel optical flow feature vector, n is the number of sequences of significantly enhanced pixel optical flow feature vectors, f is the air mass motion optical flow aggregation representation vector.

Then, the air mass motion optical flow aggregation representation vector is input into the decoder-based leak source locator to obtain the location data of the equipment leak point. In other words, the optical flow semantic aggregation features of air mass motion are used for decoding regression to locate the leak source and obtain the leak point location data. In this way, more intelligent equipment leak monitoring and leak point location can be achieved, so that when equipment leaks occur, a rapid response can be made based on the location of the leak point, providing safety protection for enterprises and reducing potential environmental risks and economic losses.

Preferably, the decoding unit 8264 is used to: subtract the 0 norm of the air mass motion optical flow aggregation representation vector from the length of the air mass motion optical flow aggregation representation vector to obtain an air mass motion optical flow aggregation isolated representation value; calculate a power function with each eigenvalue of the air mass motion optical flow aggregation representation vector as the base, and the difference of the air mass motion optical flow aggregation isolated representation value minus one as the exponent, and multiply it by the logarithm of the product of the air mass motion optical flow aggregation isolated representation value plus one and the air mass motion optical flow aggregation isolated representation value with base 2 to obtain an air mass motion optical flow aggregation leading value; after multiplying each eigenvalue of the air mass movement optical flow aggregation representation vector by the difference of the air mass movement optical flow aggregation isolated representation value minus one and dividing it by the air mass movement optical flow aggregation isolated representation value, an exponential function with a natural constant as the base is calculated to obtain the air mass movement optical flow aggregation bias value; after adding the air mass movement optical flow aggregation leading value and the air mass movement optical flow aggregation bias value, each eigenvalue of the optimized air mass movement optical flow aggregation representation vector is obtained; and, the optimized air mass movement optical flow aggregation representation vector is input into a decoder-based leakage source locator to obtain the location data of the equipment leakage point.

Specifically, as an illustrative example, V denotes the air mass motion optical flow aggregation representation vector, vᵢ denotes each eigenvalue, where vᵢ∈V, the optimization is expressed as:

$$\begin{matrix}{v}_{i}^{′} = {v}_{i}^{( n - 1 )} \times log [ ( n + 1 ) \times n ] + exp ( {v}_{i} \times \frac{n - 1}{n} ) \\ n = L - {‖ V ‖}_{0}\end{matrix}$$

In the formulas, L denotes the length of the air mass motion optical flow aggregation representation vector, V denotes the air mass motion optical flow aggregation representation vector, ∥V∥₀ denotes the 0 norm of the air mass motion optical flow aggregation representation vector, n denotes the air mass motion optical flow aggregation isolated representation value, vᵢ denotes the i-th eigenvalue of the air mass motion optical flow aggregation representation vector, exp(·) denotes the exponential operation of a numerical value, the exponential operation of the numerical value represents the calculation of the natural exponential function value with the numerical value as the power, log [.] denotes the logarithmic function value with 2 as the base, and v; denotes the i-th eigenvalue of the optimized air mass motion optical flow aggregation representation vector.

Here, the set of pixel optical flow feature vectors expresses the optical flow-based image semantic features of the image frames of the air mass contour infrared monitoring video. Therefore, after performing temporal energy level measurement image semantic feature association enhancement and temporal local energy distribution gated aggregation between optical flow frames, it is still expected to further improve the regression comprehensibility of the aggregated mapping expression of the air mass motion optical flow aggregation representation vector, thereby improving the decoding regression comprehensibility and improving the accuracy of the decoding results.

Therefore, for the high-dimensional feature manifold of the air mass movement optical flow aggregation representation vector, the eigenvalues of the feature set of the air mass movement optical flow aggregation representation vector are used as the vector field representation of the aggregation dimension, and the value of the derivative of the vector field of the air mass movement optical flow aggregation representation vector at the isolated zero position is used as the order information to fix the local position of the eigenvalues of the feature set of the air mass movement optical flow aggregation representation vector, and a bias for the reversibility of the feature regression distribution of the air mass movement optical flow aggregation representation vector is added as a reward to achieve the mapping target tracking of the regression distribution of the air mass movement optical flow aggregation representation vector for the eigenvalue position, so that the feature set of the air mass movement optical flow aggregation representation vector perceives the mapping migration to the aggregation distribution, thereby promoting the decoding regression comprehensibility of the air mass movement optical flow aggregation representation vector by improving the mapping comprehensibility of the air mass movement optical flow aggregation representation vector, and improving the accuracy of the location data of the equipment leakage point obtained by the leakage source locator based on the decoder input of the air mass movement optical flow aggregation representation vector. In this way, the source of equipment leakage can be identified and located more accurately to obtain leakage point location data, so that when equipment leakage occurs, a rapid response can be made based on the location of the leakage point, providing safety protection for the enterprise and reducing potential environmental risks and economic losses.

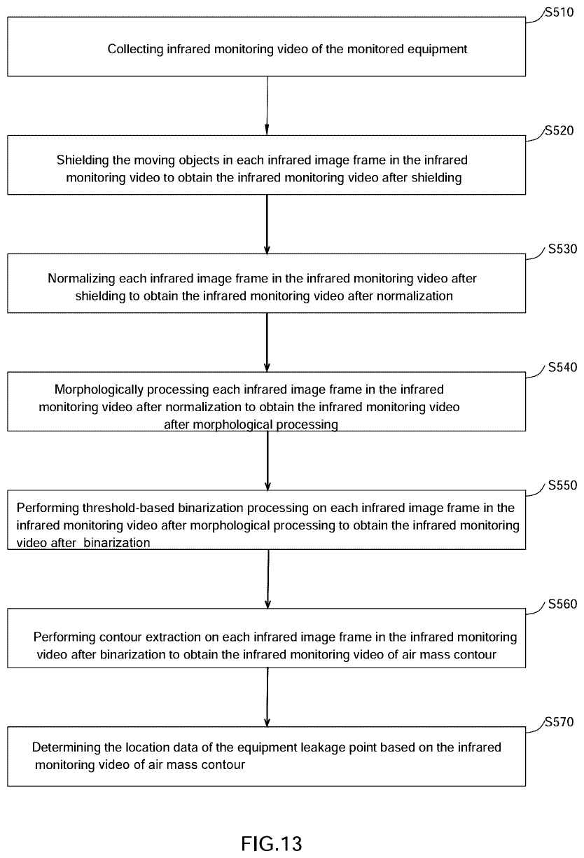

Based on the above embodiment, refer to FIG. 13, which is a flow chart of an equipment gas leakage online monitoring method according to an embodiment of the present application. As shown in FIG. 13, the online monitoring method for gas leakage of equipment according to the embodiment of the present application includes the following steps: S510, collecting infrared monitoring video of the monitored equipment; S520, shielding the moving objects in each infrared image frame in the infrared monitoring video to obtain the infrared monitoring video after shielding; S530, normalizing each infrared image frame in the infrared monitoring video after shielding to obtain the infrared monitoring video after normalization; S540, morphologically processing each infrared image frame in the infrared monitoring video after normalization to obtain the infrared monitoring video after morphological processing; S550, performing threshold-based binarization processing on each infrared image frame in the infrared monitoring video after morphological processing to obtain the infrared monitoring video after binarization; S560, performing contour extraction on each infrared image frame in the infrared monitoring video after binarization to obtain the infrared monitoring video of air mass contour; S570, determining the location data of the equipment leakage point based on the infrared monitoring video of air mass contour.

Here, those skilled in the art can understand that the specific operations of each step in the above-mentioned method for online monitoring of gas leakage have been described in detail in the description of the optical device 800 for online monitoring of gas leakage with reference to FIGS. 10 to 12 above, and therefore, its repeated description will be omitted.

In this application scenario, first, the infrared monitoring video of the monitored equipment is collected, and then the infrared monitoring video is input to a server deployed with an equipment leakage online monitoring algorithm, wherein the server can use the equipment leakage online monitoring algorithm to process the infrared monitoring video to determine the location data of the equipment leakage point.

In one example, the first explosion-proof camera and the second explosion-proof camera (or one of the cameras, such as the first explosion-proof camera or the second explosion-proof camera) can respectively collect infrared monitoring videos of the monitored equipment in the monitored scene area, and output corresponding first intelligent visual signals and second intelligent visual signals. In some examples, the first explosion-proof camera and the second explosion-proof camera can synchronously collect visible light monitoring videos of the monitored equipment and perform image fusion and splicing with the above-mentioned first intelligent visual signals and second intelligent visual signals. Specifically, the first explosion-proof camera and the second explosion-proof camera are respectively equipped with explosion-proof distribution boxes and powered by 220V AC. The above-mentioned first explosion-proof camera and the second explosion-proof camera further comprises the longwave infrared camera 100, the visible light camera 830 and the data processor 820.

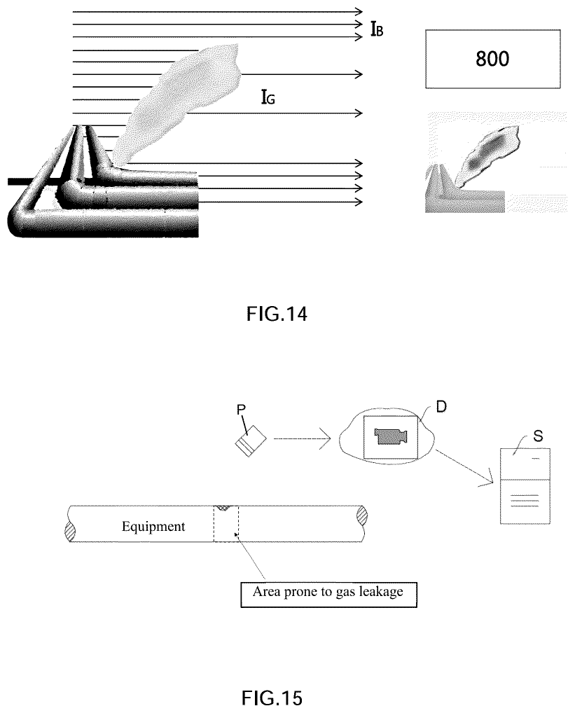

Further combined with FIG. 14, the infrared data obtained from the background is represented as I_{B}, and the infrared data after the infrared radiation passes through the black smoke (representing the suspicious air mass) is represented as I_{G} (I_{B}>I_{G} when the gas temperature is lower than the ambient temperature, and I_{B}<I_{G} when the gas temperature is higher than the ambient temperature). Therefore, by calculating the detected infrared data, it can be determined whether black smoke is generated, and thus whether the equipment is leaking. Accordingly, the calculation formula can be expressed as: ΔI=I_{B}−I_{G}. ΔI represents the difference between the infrared data from the background and the infrared data after the infrared radiation passes through the black smoke. Through the relationship between ΔI and the predetermined threshold, it can be determined whether black smoke is generated, and then whether the equipment is leaking.

FIG. 15 is an application scenario diagram of the equipment leakage online monitoring method according to an embodiment of the present application. As shown in FIG. 15, in this application scenario, first, an infrared monitoring video (e.g., D as illustrated in FIG. 15) of the monitored pipeline (e.g., P as illustrated in FIG. 15) is collected, and then the infrared monitoring video is input into a server (e.g., S as illustrated in FIG. 15) deployed with an online pipeline leakage monitoring algorithm, wherein the server can use the online pipeline leakage monitoring algorithm to process the infrared monitoring video to determine the location data of the pipeline leakage point.

It is worth mentioning that in this application, the original video data is obtained from the infrared camera, and the video data can be input into the processing module of the algorithm in the form of a single-frame grayscale image. In addition, moving objects (such as people, vehicles, trees, etc.) in the video frame are shielded to eliminate interference with the estimation of the direction of air mass movement. The mixed Gaussian background modeling algorithm (MOG2) in OpenCV can be used, and the parameters can be optimized to adapt it to industrial scenarios. MOG2 performs statistical analysis on the brightness of each pixel in each frame of the image, judges and shields pixels that exceed the normal brightness distribution range, thereby shielding moving objects.

In addition, the moving objects (such as people, vehicles, trees, etc.) in the video frame are shielded to eliminate interference with the estimation of the direction of air mass movement. The mixed Gaussian background modeling algorithm (MOG2) in OpenCV can be used, and the parameters can be optimized to adapt it to industrial scenarios. MOG2 performs statistical analysis on the brightness of each pixel in each frame of the image, judges and shields pixels that exceed the normal brightness distribution range, thereby shielding moving objects.

Furthermore, in another example of the present application, a reverse optical flow algorithm can also be used to reversely calculate the motion trajectory of the air mass. By reversely processing the video frames in a time series, the reverse motion vector of the air mass in each frame is determined to trace the motion path of the air mass. Then, all the reverse motion vectors are merged to generate a complete reverse motion trajectory of the air mass, and the trajectory is analyzed to identify the starting point of the trajectory, that is, the source position of the air mass. Finally, by analyzing the spatial position of the starting point of the trajectory, combined with environmental information and possible sources of air mass generation, the specific source position and volume of the air mass are finally determined.

Specifically, the inverse optical flow algorithm is a computer vision technology used to estimate the inverse process of object motion in an image sequence. Unlike conventional optical flow algorithms, the inverse optical flow algorithm does not predict the motion of the next frame from the current frame, but reversely calculates the motion from the next frame of the sequence to the previous frame. The advantage of this is that when the final position of the object is known, the motion trajectory of the object can be tracked in reverse, so as to find the starting position or source of the object and further analyze and obtain the volume information of the air mass.

The application scenarios of the inverse optical flow algorithm include but are not limited to environmental monitoring, meteorology, and other fields that require tracking the path of an object. For example, when tracking the spread of pollutants in the atmosphere, the inverse optical flow algorithm can be used to determine the source of the pollutants. In addition, the inverse optical flow algorithm can also be used for specific applications in video analysis, such as target tracking and behavior recognition.

When implementing the inverse optical flow algorithm, the following key steps need to be considered: 1. Starting from the next frame of the video sequence, select a target region. 2. Use the optical flow algorithm to calculate the position of the region in the previous frame, which involves calculating the gradient of the image and estimating the motion of the pixels. 3. Reversely update the position of the target region and repeat the above process until the first frame of the sequence is reached. 4. Determine the starting point or source position of the object by analyzing the entire reverse motion trajectory.

It is worth noting that the inverse optical flow algorithm may face some challenges in its implementation, such as the need to deal with occlusion problems in image sequences, illumination changes, etc. In addition, the efficiency and accuracy of the algorithm also depend on the specific optical flow estimation method and parameter settings used.

Based on the above embodiments, another exemplary embodiment of an electronic device is also provided in the embodiments of the present application. In some possible implementations, the electronic device in the embodiments of the present application may include a memory, a processor, and a computer program stored in the memory and executable on the processor, wherein the processor can implement the steps of the equipment gas leakage online monitoring method in the above embodiments when executing the program.

The embodiment of the present application also provides a computer-readable storage medium, on which computer-executable instructions are stored. When the computer-executable instructions are executed by a processor, the online monitoring method for equipment gas leakage according to the embodiment of the present application described with reference to FIG. 13 can be executed. The computer-readable storage medium includes, but is not limited to, for example, volatile memory and/or non-volatile memory. The volatile memory may, for example, include a random-access memory (RAM) and/or a cache memory (cache), etc. The non-volatile memory may, for example, include a read-only memory (ROM), a hard disk, a flash memory, etc.

The embodiment of the present application also provides a computer program product or a computer program, which includes computer executable instructions, and the computer executable instructions are stored in a computer readable storage medium. The processor of the computer device reads the computer executable instructions from the computer readable storage medium, and the processor executes the computer executable instructions, so that the computer device executes the equipment gas leakage online monitoring method according to the embodiment of the present application.

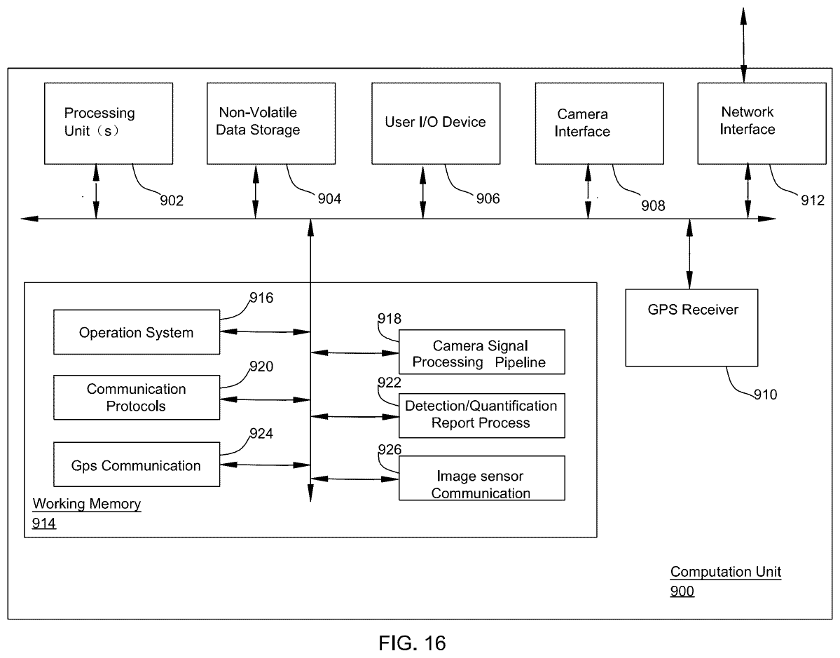

FIG. 16 shows a block diagram of an example computation unit 900 of the camera. Computation unit 900 comprises one or more processing units 902, non-volatile memory 904, user input/output device(s) 906, a camera interface 908, a GPS receiver 910, a network interface 912, and a working memory 914. Processing unit(s) 902 execute data and code stored in working memory 914, causing the camera to carry out its various functions. Non-volatile memory 904 (e.g. read-only memory) provides storage for data and code (e.g. boot code and programs) that are retained even when the camera is powered down. User input/output device(s) 906 (e.g. power button, keypad, touchscreen, and so on) facilitate communication between a user and the camera. Camera interface 908 facilitates communication between the image sensor(s) of the camera and computation unit 908. GPS receiver 910 is configured to receive GPS signals that are used to compute the location of the hosting camera. Network interface 912 facilitates communication (e.g. LTE, Wi-Fi, Ethernet, etc.) between computation unit 900 and a network. Working memory 914 (e.g. random-access memory) provides temporary storage for data and executable code, which is loaded into working memory 914 during start-up and continued operations. Working memory 914 comprises operating system module 916, camera signal processing pipeline module 918, communications protocols module 920, detection report processing module 922, GPS communication module 924, and image sensor(s) communication module 926. Operating system module 916 provides coordination of control of the various running programs and modules of computation unit 900 and provides a means by which higher level program modules can run on the hardware of computation unit 900. Camera signal processing pipeline module 918 facilitates the monitoring of the image data captured by the image sensors of the hosting camera. Communications protocols module 920 facilitates the communication of information into and out of computation unit 900 via network interface 912. Detection/quantification report process module 922 carries out various processes that analyze image data acquired by the image sensors of the hosting camera and generate a detection report based on such analysis. GPS communication module 924 facilitates the acquisition of location data from GPS receiver 910 and the provision of location data to users/monitors in circumstances where the location of the camera is needed or desired. Image sensor communication module 926 facilitates communication between computation unit 900 and cameras/image sensor(s) connected to camera interface 908, for example to receive images to be analyzed.

In the described example computation unit 900, operating system module 916, camera signal processing pipeline module 918, communications protocols module 920, detection report processing module 922, GPS communication module 924, and image sensor(s) communication module 926 are shown as code modules within working memory 914, to facilitate clear explanation. It should be understood, however, that operating system module 916, camera signal processing pipeline module 918, communications protocols module 920, detection report processing module 922, GPS communication module 924, image sensor(s) communication module 926, and any other functional modules can be implemented with software, hardware, firmware, or any combination thereof.

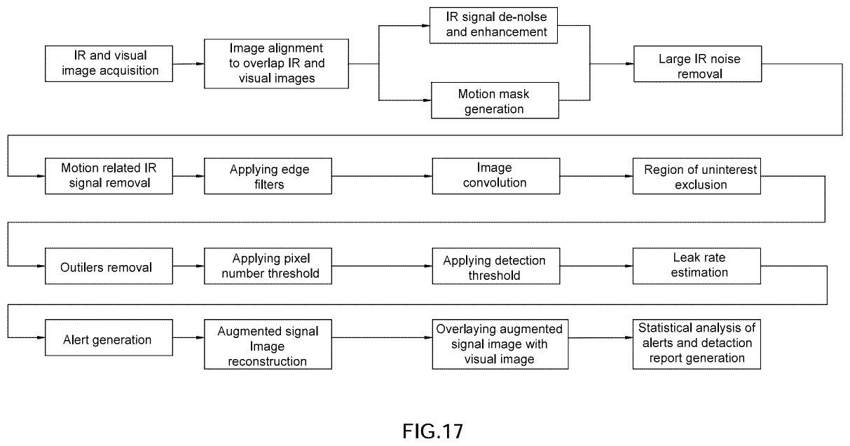

FIG. 17 is a diagram showing the main steps of gas leak detection and quantification, which may be implemented by camera signal processing pipeline module 918 and/or detection/quantification report process module 922.

What is claimed is:

1. A hydrocarbon gas detection system, comprising:
a longwave infrared camera which comprises a camera sensor;
a spectral filter disposed in a light path of said camera sensor, wherein said spectral filter is made of a material selected from the group consisting of calcium fluoride, zinc sulfide, magnesium fluoride, and silicon; and
a computation unit arranged to process image data of said longwave infrared camera for the hydrocarbon gas detection.

2. The hydrocarbon gas detection system according to claim 1, wherein said longwave infrared camera comprises a camera lens, wherein said spectral filter is positioned in front of said camera lens.

3. The hydrocarbon gas detection system according to claim 1, wherein said longwave infrared camera comprises a camera lens, wherein said spectral filter is positioned between said camera lens and said camera sensor.

4. The hydrocarbon gas detection system according to claim 1, wherein said spectral filter is functioning as a camera lens in front of said camera sensor.

5. The hydrocarbon gas detection system according to claim 1, wherein said spectral filter has a thickness of 1-10 mm.

6. The hydrocarbon gas detection system according to claim 1, wherein said spectral filter comprises a 5 mm calcium fluoride window.

7. The hydrocarbon gas detection system according to claim 1, wherein said spectral filter comprises a 7 mm zinc sulfide window.

8. The hydrocarbon gas detection system according to claim 1, wherein said spectral filter comprises a 2 mm magnesium fluoride window.

9. The hydrocarbon gas detection system according to claim 1, wherein said spectral filter comprises a 5 mm silicon window.

10. The hydrocarbon gas detection system according to claim 1, further comprising a visual camera which is communicated to said computation unit.

11. The hydrocarbon gas detection system according to claim 2, wherein said longwave infrared camera further comprises a camera shell which comprises a shield which is positioned above said camera lens.

12. The hydrocarbon gas detection system according to claim 2, wherein said longwave infrared camera further comprises a germanium window which is positioned in front of said spectral filter.

13. The hydrocarbon gas detection system according to claim 10, further comprising a sapphire window which is positioned in front of said visual camera.

14. The hydrocarbon gas detection system according to claim 1, wherein the hydrocarbon gas is selected from the group consisting of methane, ethane, propane, butane, and propene.

15. The hydrocarbon gas detection system according to claim 1, wherein the longwave infrared camera is used to collect infrared monitoring video of a monitored equipment, and the computation unit comprises a data processor, the data processor is used to process the infrared monitoring video to obtain monitoring results, and the monitoring results are location and gas flow data of an equipment leakage point, wherein the data processor comprises:
a moving object shielding module which is used for shielding moving objects in each infrared image frame in an infrared surveillance video to obtain a shielded infrared surveillance video;
an infrared image frame normalization module which is used for normalizing each infrared image frame in the infrared surveillance video after the shielding process to obtain a normalized infrared surveillance video;
a morphological processing module which is used for performing morphological processing on each infrared image frame in the normalized infrared surveillance video to obtain a morphologically processed infrared surveillance video;
a threshold binarization module which is used for performing a threshold-based binarization process on each infrared image frame in the infrared surveillance video after the morphological process to obtain a binarized infrared surveillance video;
a contour extraction module which is used for performing contour extraction on each infrared image frame in the infrared monitoring video after the binarization process to obtain an infrared monitoring video of an air mass contour; and
an equipment leakage point location detection module which is used to determine location data of the equipment leakage point based on the infrared monitoring video of the air mass contour.

16. The hydrocarbon gas detection system according to claim 15, wherein the equipment leakage point location detection module comprises:
an optical flow algorithm processing unit which is used to process the infrared monitoring video of the air mass contour using an optical flow algorithm to obtain a set of pixel optical flow feature vectors;
a semantic association enhancement unit configured to perform semantic association enhancement on each pixel optical flow feature vector in the set of pixel optical flow feature vectors based on feature energy level measurement associated radiation to obtain a set of enhanced pixel optical flow feature vectors;
a feature aggregation unit which is used for inputting the set of enhanced pixel optical flow feature vectors into a feature aggregation network based on feature local energy distribution gating to obtain an air mass motion optical flow aggregation representation vector; and
a decoding unit which is used for inputting the air mass motion optical flow aggregation representation vector into a leak source locator based on a decoder to obtain the position data of the equipment leak point.

17. A methane gas detection system, comprising:
a longwave infrared camera which comprises a camera sensor;
a spectral filter which is a calcium fluoride window; and
a computation unit arranged to process image data of said longwave infrared camera for the methane gas detection.

18. The methane gas detection system according to claim 17, wherein said camera sensor and said calcium fluoride window are configured to allow light transmission between 7.5 microns and 8.5 microns.

19. The methane gas detection system according to claim 17, wherein said longwave infrared camera comprises a camera lens, wherein said spectral filter is positioned in front of said camera lens.

20. The methane gas detection system according to claim 17, wherein said longwave infrared camera comprises a camera lens, wherein said spectral filter is positioned between said camera lens and said camera sensor.
